(19) United States
(12) Patent Application Publication
(10) Pub. No.: US 2007/0096874 A1
(43) Pub. Date: May 3, 2007

(54) Distributed RFID interrogation system and method of operating the same

(76) Inventor: James Mravca, Sunnyvale, CA (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/259,780

(22) Filed: Oct. 27, 2005

(51) Int. Cl. H04Q 5/22; G05B 23/02; G06K 7/00; G08B 13/14

(52) U.S. Cl. 340/10.1; 340/3.5; 340/572.1; 235/436

(57) ABSTRACT

A system and method are provided for interrogating passive radio frequency identification (RFID) transponders located in compartmentalized areas such as on shelves or in other spatially-partitioned storage areas. The system includes a controller and a plurality of minimal function RFID readers coupled to the controller via a network-compatible cable. The controller is configured to address a subset of at least one reader at a time to interrogate the RFID transponders located in at least one of the compartmentalized areas. The readers are each give a physical location and a unique address, through which the controller would know the locations of the RFID transponders being interrogated.

### CROSS REFERENCE TO RELATED APPLICATIONS

The present application claims the benefit of and priority to U.S. Provisional Application Ser. No. 60/622,562 entitled “Distributed RFID Interrogation System and Method,” filed on Oct. 26, 2004, which is incorporated herein by reference in its entirety.

### FIELD OF THE INVENTION

The present invention is directed to system and methods of interrogating ‘passive’ radio-frequency identification (RFID) transponders, and more particularly to a distributed RFID interrogation system for interrogating RFID transponders located in spatially-partitioned areas.

### BACKGROUND OF THE INVENTION

RFID technologies are widely used for automatic identification. A basic RFID system includes an RFID tag or transponder carrying identification data and an RFID interrogation device or reader that reads and/or writes the identification data. An RFID tag typically includes a microchip for data storage and processing, and a coupling element, such as an antenna coil, for communication. Tags may be classified as active or passive. Active tags have built-in power sources while passive tags are powered by radio waves received from the reader and thus cannot initiate any communications. Instead, passive RFID transponders sense the presence of an interrogating signal, and respond to it by varying their reflection coefficient as a function of time. An RFID reader operates by writing data into the tags or interrogating the tags for their data through a radio-frequency (RF) interface. An RFID reader for interrogating passive tags is typically designed to receive from the tags a backscattered portion of a signal transmitted from the reader and to extract tag data from received signal.

RFID technology has found wide applications including those in retailing, where it is often of interest to use RFID tags and interrogation devices to monitor products offered to the consumer. In such an application, the RFID system is intended to replace the laborious and expensive manual count of the number of units for each product type remaining on shelves or in a display area.

RFID transponders may operate in various frequency bands, such as 13.56 MHz (‘HF’), approximately 860-960 MHz (UHF), or 2.4-2.5 GHz (microwave). Low-frequency transponders typically employ relatively expensive multi-turn inductive coils to extract power from the radio-frequency signals from the interrogating device. Because such coils are expensive and relatively difficult to construct, high-frequency transponders are relatively larger and more expensive compared to UHF or microwave transponders. Thus, from the viewpoint of reduced size and cost, transponders operating at higher frequencies are preferred for identification of consumer products.

On the other hand, conventional UHF and microwave interrogation devices are standalone devices, typically costing up to several thousand dollars each, so that it is impractical to use more than a few readers to monitor a retailing area. In consequence, high-power readers with a large coverage area must be employed for higher frequency transponders. The size of the coverage area for a UHF or microwave reader can be as large as several meters in diameter, depending on the radiated power, type of transponders, and environment. The exact location of the responding transponders is then difficult to ascertain, since they may be anywhere within the coverage area of the reader. Furthermore, particularly when metallic shelving is employed to contain items for display, the metallic constituents of the shelving may scatter the impinging radiation from the readers, causing shadowed regions where transponders do not respond to the reader. Absorption and scattering from the packaging and contents of the stocked items themselves may also interfere with propagation of the signals from the reader and the responding signals from the transponders. To ensure good coverage with only a few readers, the readers must be physically moved through the region to be monitored by stocking clerks. As a result, the cost of monitoring is increased, and the consistency of coverage is limited by the skill and attention of the monitoring personnel.

What is needed is a system for interrogating UHF and/or microwave RFID tags in retail display areas and other similar environments that provides consistent coverage without manual intervention.

### BRIEF SUMMARY OF THE INVENTION

The embodiments of the present invention provide a system and method for interrogating passive radio frequency identification (RFID) transponders located in compartmentalized areas such as on shelves or in other spatially-partitioned storage areas. The system includes a controller and a plurality of minimal function readers coupled to the controller via a network-interface. The controller is configured to address a subset of at least one reader at a time to interrogate the RFID transponders located in at least one of the compartmentalized areas. The readers are each given a physical location and a unique address, through which the controller would know the locations of the RFID transponders being interrogated.

In one embodiment, the plurality of minimal-function readers are a number of simplified, highly-miniaturized, low-power readers dispersed along the length of a substantially-conventional networking cable. Each reader receives its power over the cable, and simultaneously employs the cable to communicate with the controller, which may be a relatively-sophisticated controlling device, and optionally with the other readers on the cable. Low reader power ensures that the range of coverage is small, so that a transponder responding to a particular reader must be located very close to the reader. The total coverage area is large because many readers can be conveniently and precisely installed in a single cable placement. Conventional networking technology can be used to keep total system cost low. The system may be used to interrogate UHF and/or microwave RFID tags in retail display areas and similar environments, in which the system can provide approximate location of the counted items and consistent coverage even in the presence of metallic shelving without manual intervention and with low installation and operating costs.

The embodiments of the present invention also provide a method for interrogating RFID tags in compartmentalized areas. The method comprises the steps of placing a plurality of RFID readers coupled to a controller through a network interface in the compartmentalized areas, addressing a first subset of at least one of the plurality of RFID readers from the controller to interrogate RFID tags located in a first subset of at least one of the compartmentalized areas during a first time period, and addressing a second subset of at least one of the plurality of RFID readers from the controller to interrogate RFID tags located in a second subset of at least one of the compartmentalized areas during a second time period after the first time period.

In one embodiment, the RFID readers are placed in the compartmentalized areas such that at least one of the plurality of RFID readers is situated in each area, the plurality of RFID readers are coupled to the controller via a network-compatible cable, and the controller addresses each subset of the readers by sending a reader interface packet down the network-compatible cable, the reader interface packet including at least one unique address corresponding to a subset of RFID readers.

### BRIEF DESCRIPTION OF THE DRAWINGS

FIG. 1 is a block diagram of a distributed RFID interrogation system according to one embodiment of the inventive system.

FIG. 2 is a block diagram of an exemplary application scenario for the distributed RFID interrogation system according to one embodiment of the inventive system.

FIG. 3 is a block diagram illustrating a network interface in the distributed RFID interrogation system according to one embodiment of the present invention.

FIG. 4 is a block diagram of an exemplary encapsulated reader interface packet used by the distributed RFID interrogation system according to one embodiment of the present invention.

FIG. 5 is a block diagram of a minimal-function reader in the distributed RFID interrogation system according to one embodiment of the present invention.

FIG. 6 is a block diagram of an RFID radio in the minimal-function reader according to one embodiment of the present invention.

FIG. 7 is a block diagram of an exemplary interface for the RFID radio according to one embodiment of the present invention.

FIG. 8 is a block diagram of a portion of a network-compatible cable in the distributed RFID interrogation system according to one embodiment of the present invention.

FIG. 9 is a block diagram of a portion of a network-compatible cable in the distributed RFID interrogation system according to an alternative embodiment of the present invention.

### DETAILED DESCRIPTION OF THE INVENTION

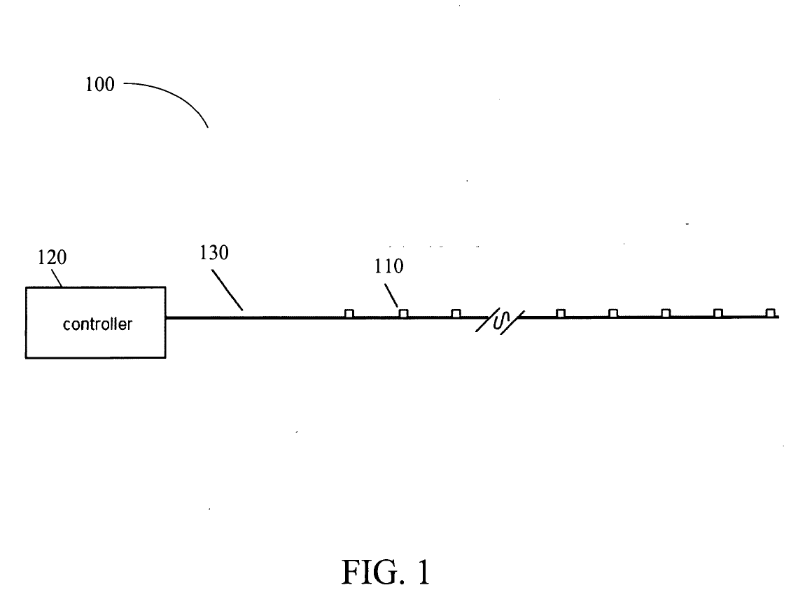

The embodiments of the present invention provide a distributed RFID interrogation system. As shown in FIG. 1, an overall block diagram of a distributed RFID system 100 according to one embodiment of the present invention comprises a plurality of networked minimal-function readers (MFR) 110 and a controller 120 in communication with the MFRs via a network interface. In one embodiment, the MFRs 110 are distributed along at least one network-compatible cable (cable) 130. Each MFR 110 is configured to transmit a continuous or amplitude-modulated signal and to detect backscattered signals from nearby tags. The controller 120 is a relatively sophisticated controller and is configured to manage higher-level RFID communication protocols and functions, such as inventory functions, access control, collision resolution, etc., and optionally some physical layer functions such as instantaneous power of transmitted signals and interpretation of the received amplitude. The controller 120 may use a conventional network interface, such as the Institute of Electrical and Electronics Engineers (IEEE) 802.3 standard “Ethernet” network interface, to communicate with the minimal-function readers 110 along the cable 130. The network-compatible cable 130 is equipped with an interface connector at one or both ends that is compatible with the appropriate standard network interface, such as the well-known ‘Category 5 Ethernet’ RJ45 interface. The cable 130 can be formed using one or more of conventional network cables that are slightly modified, as described in more detail below, to incorporate and support operation of the minimal-function readers 110. In one embodiment, each MFR 110 is associated with a unique address in the network, such as a unique IEEE-802.3-compliant medium access control (MAC) address.

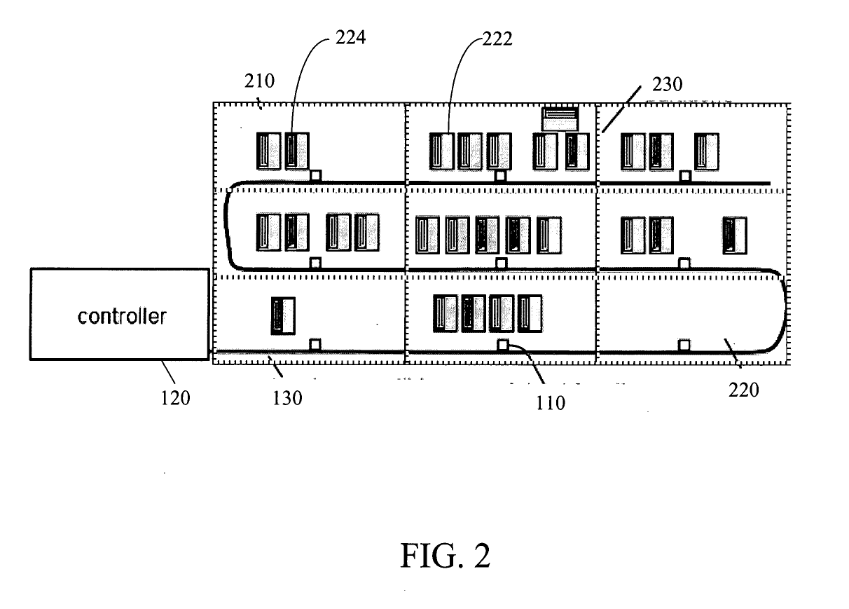

The distributed RFID system (system) 100 is useful for interrogating tags located in compartmentalized areas. One application scenario for system 100 is in inventory control, as depicted in FIG. 2, where the network-compatible cable 130 is installed on a retail display shelf 210 having a plurality of partitioned areas 220 separated by shelf partitions 230 made of, for example, a metallic material. At least some of the partitioned areas 220 are occupied by stocked merchandise or items 222 each having a RFID tag 224 attached thereto. In one embodiment, the cable placement and MFR locations on the cable are adjusted to ensure that each partitioned area 220 is completely visible from at least one MFR 110. The effect of the shelf partitions 230 on the effective coverage area can be found by experiment, simulation, or past experience. If the shelf partitions 230 do not act to limit the effective coverage area of the minimal-function readers 110, two or more neighboring partitioned areas 220 can share one MFR 110. But the condition that each partitioned area 220 be covered may simply be satisfied by placing at least one minimal-function reader 110 in each partitioned area 220, especially when shelf partitions 230 are made of metal. Optionally, more than one readers 110 may be placed in each partitioned region 220, in order to provide redundant reading capability, ensure thorough coverage of the addressed area, and/or ensure coverage in the event of failure of a particular reader. The cable 130 and the MFRs 110 should also be placed on the shelf 210 in a convenient fashion so as to minimize interference with normal shelf functions, such as display, consumer access, and restocking.

In one embodiment of the present invention, the controller 120 addresses one or more MFRs 110, causing them to transmit appropriate interrogation signals that energize and activate the tags 224 on the items within the coverage areas of the at least one MFR. The interrogation signals may be combinations of continuous-wave (CW) and varying-amplitude signals, such as Amplitude Shift Keying (ASK) or non-constant-envelope Binary Phase Shift Keying (BPSK) signals. In inventory applications of this type, updates may only need to be accomplished on an occasional or periodic basis, such as once per hour or once per day. Thus there is no need for all MFRs 110 on a single cable 130 to operate simultaneously. In general, only a subset of as few as a single MFR 110 should be in operation at any given time. The number of MFRs 110 used simultaneously may be chosen through a tradeoff of the required DC power, data capacity on the network cable 130, and desired frequency for updating the information. Since each MFR 110 has a unique physical address within the network, the controller 120 can always establish the identity of the MFR 110 providing information on any given tag, and thus through knowledge of the physical location of that reader 110 can infer to good precision the location of the tagged item. The physical location of each MFR 110 can be manually programmed into the controller 120. Alternatively, in some circumstances, one or more tags 224 with known ID's in known locations can be temporarily or permanently placed in close proximity to each MFR 110 to help the controller locate the MFR. By examining which tags 224 can be seen by each reader, this approach can also be used to establish the approximate readable volume associated with each MFR 110.

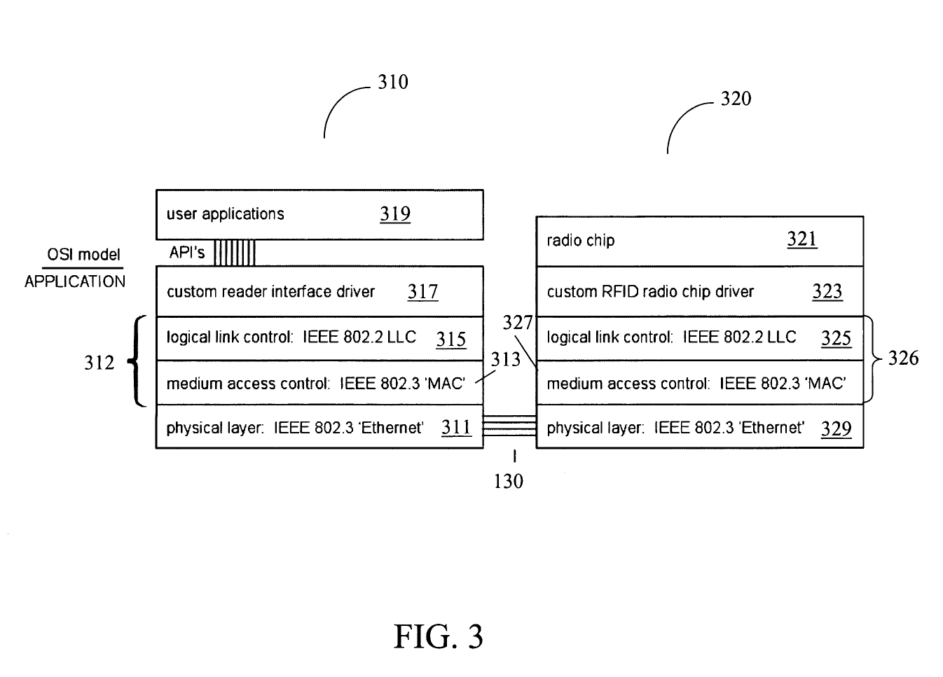

An exemplary communication architecture for the distributed reader system 100 using, for example, the Open Systems Interconnect (OSI) protocol is shown in FIG. 3. OSI is a well-known industry-wide protocol standard consisting of seven well-defined layers. In the simplest implementation where the MFRs 110 are distributed along the cable 130 so that there is no need for a NETWORK layer or full network capability for system 100, only the first two layers (the PHYSICAL and LINK layers) of the OSI hierarchy are supported in system 100. As shown in FIG. 3, an OSI hierarchy 310 within the controller 120 includes a physical layer 311, a link layer 312 having a logic link control part 315 and a medium access control part 313 for communicating with the physical layer 311, a custom reader interface driver 317 for communicating with the logic link control part 315, and user applications 319 for communicating with the reader interface driver 317 via an Application Program Interface. In each MFR 110, an OSI hierarchy 320 includes an RFID radio 321, a custom RFID radio driver 323 for communicating with the RFID radio, a link layer 326 having a medium access control part 327 and a logic link control part 325 for communicating with the custom RFID radio driver 323, and a physical layer 329 for communicating with the medium access control part 327. The physical layer 311 in the controller 120 and the physical layer 329 in the MFR 110 communicate with each other via the cable 130.

In one exemplary embodiment, the IEEE 802.3 standard is used as a communications standard. In this example, the custom reader interface driver 317 in the controller 120 generates specialized Reader Interface (RIN) packets, each being associated a unique IEEE-802.3-compliant MAC address that identifies a particular minimal-function reader 110 to receive the packet. Other layer-2 technologies could be used, with appropriate addressing substituted as needed. The packets may be encapsulated in standard headers, such as IEEE 802.3-compliant preamble and header, and are transmitted over the network-compatible cable 130. The relevant minimal-function reader 110 to which a packet is addressed recognizes the packet's unique MAC address and extracts the RIN packet from the 802.3 header. The custom driver 323 in the MFR 110 interprets the RIN packet and controls the RFID radio 321. Data from the minimal function reader 110 undergoes the reverse process of encapsulation and decapsulation in the controller 120 to provide data to the custom reader interface driver 317 and hence to the user applications 319.

Alternative implementations can employ conventional IEEE 802.3 layer-2 switching to allow a single controller to communicate with a number of physical collision domains, but such implementations must contend with switch buffer latency. Potential delays in packet delivery in larger systems would necessitate longer buffering times and thus more complex function support in the minimal-function reader units 110, with consequent increase in cost. A single reader controller 130 could in principle control a number of physically-separated minimal-function-readers 110 by employing a conventional networked architecture such as TCP/IP (Transmission Control Protocol/Internet Protocol), but the potentially long and possibly variable latencies in a networked environment would tend to force the individual reader units 110 to become more intelligent and thus more expensive.

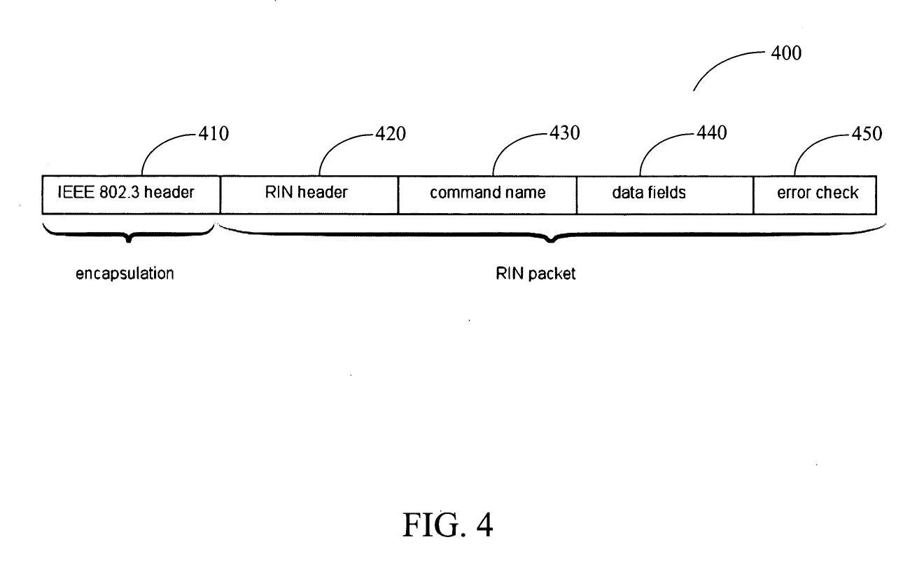

An exemplary architecture for a RIN packet 400 is shown in FIG. 4. The packet 400 is encapsulated by a header such as an IEEE 802.3 header 410, and includes some or all of a RIN header 420, a command name 430, one or more appropriate data fields 440, and possibly some additional post-fixed error check data or flags 450. Within the RIN packet 400, the RIN header 420 describes a protocol version, type of packet, and other control data, the command name 430 describes the requisite action, and the data fields 440 are appended as needed. The error check 450 may be appended on the RIN packet, or the encapsulating layer 410 may be relied upon for reliable packet delivery. Using a register-based control system as described below, a small number of commands suffices to provide considerable flexibility in the operation of the minimal-function reader 110.

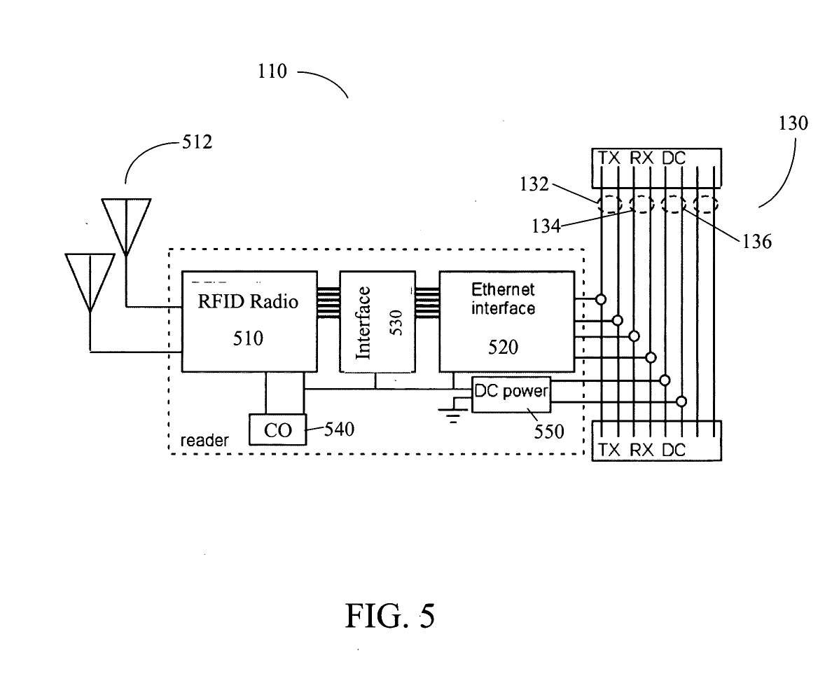

A simplified block diagram of an exemplary minimal-function reader 110 is shown in FIG. 5. The MFR 110 as shown in FIG. 5 allows the system 100 to be implemented without incurring excessive costs, but more elaborate RFID readers could also be used as the MFRs 110 when appropriate. As shown in FIG. 5, the reader 110 includes an RFID radio 510 connected to one or more antennas 512, an Ethernet interface 520 coupled to the cable 130, an interface module 530 coupled between the RFID radio 510 and the Ethernet interface 520, a crystal oscillator 540 coupled to the RFID radio 510, the Ethernet interface 520, and the interface module 530, and a DC power module 550 coupled to each of the above components in the reader 110 and to the cable 130.

The RFID radio 510 is configured to generate continuous wave or amplitude-modulated output signals and to extract information from signals backscattered from the tags 224 by detecting variations therein. The RFID radio 110 includes a frequency synthesizer (not shown) locked to a low-frequency reference signal provided by the crystal oscillator 540, and modules for facilitating instantaneous output RF power control, transmit amplification, and I and Q down-conversion of received signals. The interface module 530 is configured to instruct the RFID radio 510 as to the frequency and instantaneous output power desired, and to receive the I and Q baseband outputs. The interface module 530 may be configured with only the capability of sending sampled values of the I and Q outputs to the controller 120, but this is very inefficient, and in general the interface module 530 would incorporate added capability to save a sequence of sampled values and send them in a single longer packet to the controller. The Ethernet interface 520 is a standard commercial single-chip Ethernet controller, capable of sending and receiving packets using the network-compatible cable 130. The Ethernet interface 520 is also configured to de-encapsulate packets from the controller 120 and provide them over a bus to the interface chip 530, and to encapsulate responses therefrom.

In one embodiment, cable 130 includes a plurality of twisted pairs including, for example, a transmit (TX) twisted pair 132, a receive (RX) twisted pair 134, a DC power twisted pair 136, etc. The DC power twisted pair 136 of the cable 120 is used to provide DC power to the minimal-function readers 110 through the DC power module 550. While standard approaches such as those according to the IEEE 802.3af standard might be used, a custom powering arrangement may also be used to avoid complex power regulation circuitry in the minimal-function readers 110. It is also possible to include comparators and decoding logic to return digital symbols from the interface module 530 to the Ethernet module 520 rather than digitized analog data, or to incorporate a simple Peripheral Interface Controller (PIC) microprocessor and to implement full RFID communications protocols within the reader 110, so that it becomes a conventional reader with a simplified interface.

In a conventional switched Ethernet network, the transmit (TX) pair for one transceiver is the receive (RX) pair for the transceiver on the other end of the cable. Such an arrangement can be employed for the distributed reader system 100, but a simpler alternative arrangement is to revert to the true common-medium approach of the original Ethernet networks and use the same TX twisted pair 132 to transmit to all distributed readers, and the corresponding RX pair 134 to receive from all distributed readers. Since the state of shelves changes slowly, in practice only one or a few readers will be operational at any given time, so the probability of packet collisions is low and can be dealt with at the application level rather than at the physical layer.

The antennas may be any conventional small antennas. For example, a tip-loaded dipole or folded dipole may be incorporated into the reader package, and a patch antenna or patch array may alternatively or additional used. Various surface-mount antennas are also available, and provide some size reduction at the cost of decreased efficiency. A single transmit/receive antenna may be employed, using a directional coupler or circulator to extract the reflected signal from the tags. Alternatively, a separate decoupled receive antenna can be employed for the reverse link from tag to reader. In another alternative implementation two separate TX/RX antennas can be provided to ensure diversity—that is, if a tag is in a local null of the field excited by one antenna, it is unlikely to be in the null of the second antenna given that the two antennas are spaced at least a quarter of a wavelength apart. The reader can be provided with a switch arrangement to alternately employ the main or diversity antenna, in order to ensure reliable read of all tags present on the shelf.

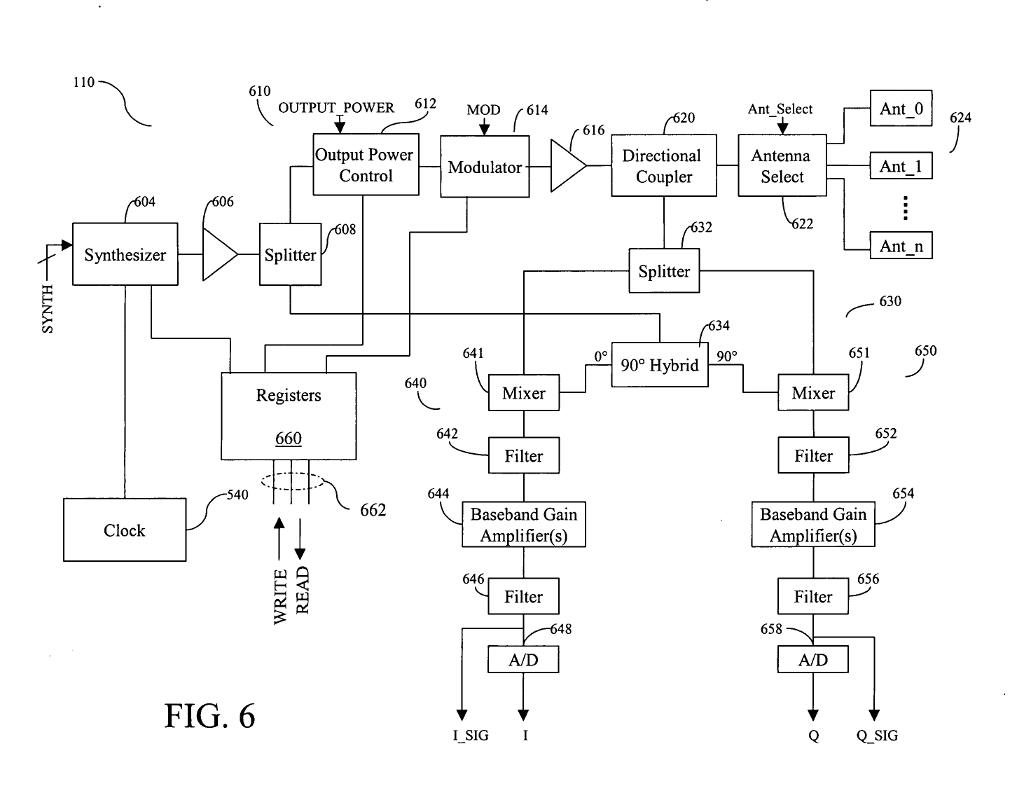

FIG. 6 is a simplified block diagram of the RFID reader 510 according to one embodiment of the present invention. As shown in FIG. 6, reader 510 includes a frequency synthesizer 604 configured to generate a continuous wave (CW) signal with reference to the clock signal from the crystal oscillator 540, and a local oscillator (LO) buffer amplifier 606 coupled to synthesizer 604 and configured to amplify the CW signal. LO buffer amplifier 606 also protects the synthesizer from disturbances created from other parts of reader 510. LO buffer amplifier 606 may be implemented using conventional means.

Reader 510 further includes a transmit (TX) chain 610 configured to form and transmit TX signals for interrogating the tags 224, and a receive (RX) chain 630 configured to receive backscattered RF signals from tags 224, and to generate I and Q output signals. TX chain 610 includes an output power control module 612, a modulator 614, and an amplifier 616. RX chain 630 includes a splitter 632, a 90° hybrid 634, an I-branch 640, and a Q-branch 650.

Reader 510 further includes a splitter 608 coupled between LO buffer amplifier 606 and TX/RX chains 610 and 630 and configured to split the CW signal from LO buffer amplifier 606 into a TX CW signal for the TX chain and a RX LO signal for the RX chain. When more than one antenna can be used by reader 510, reader 510 may also include an antenna select module 622 configured to select one of a plurality of antenna 624 for broadcasting the TX signal or receiving the RF signal. Reader 510 further includes a directional coupler 620 coupled between antenna select module 622 and TX/RX chains 610 and 630. Directional coupler 620 is configured to pass the TX signal from the TX chain 610 to at least one antenna through antenna select module 622 and to couple the RF signals by the antenna to the RX chain 630.

A simple and flexible means of controlling of the RFID radio 510 is through the use of a number of data registers, which can be included in a register block 660 in the RFID radio 510. Bits in the registers may be assigned to control and/or reflect the state of various functions in the radio 510, such as power management, digital-analog converters (DACs), attenuators, clock buffers, comparators, local oscillator (LO) status, modulation, anti-alias and baseband filtering, pulse shaping, frequency and amplitude locking, and phase-locked loop (PLL) status. In addition, values of ranges of bits within the registers may be used to adjust parameters relevant to the operation of the reader 510, such as the modulus of dividers in the synthesizer 604, values of taps used in finite-impulse-response filters also in the synthesizer 604, or other variable parameters. Registers in the register block 660 may be written to and/or read from by the controller 120 via a serial port interface (SPI) 662, as discussed below.

Referring still to FIG. 6, in one embodiment of the present invention, in TX chain 610, output power control module 612 is configured to adjust the power level of the TX CW signal according to corresponding bits stored in the register block 660, and modulator 614 is configured to form the TX signal by modulating and optionally amplifying the modulated TX CW signal.

In one embodiment of the present invention, RX chain 630 includes I-branch 640 configured to generate at least one in-phase signal I-SIG and/or digitized in-phase signal I-DIG based on a RF signal received from a tag 224, and Q-branch 650 configured to generate at least one quadrature signal Q-SIG and/or digitized quadrature signal Q_DIG based on the RF signal received from the tag. RX chain 630 further includes splitter 632 configured to receive the RF signal from the directional coupler 630 and to split the received RF signal into two RF_receive signals going separately into the I-branch 640 and the Q-branch 650. RX chain 630 further includes a 90° (quarter wavelength) hybrid 634 configured to receive the RX LO signal from the splitter 608 and to split the RX LO signal into a first LO signal in-phase with the RX LO signal and going into the I-branch 640, and a second LO signal with a 90° phase shift from the RX LO signal and going into the Q-branch 650.

I-branch 640 and Q-branch 650 function to demodulate ASK or EPCglobal class-1 signals from the tags and may include conventional heterodyne or super-heterodyne topology for I/Q demodulators. As shown in FIG. 6, I-branch 640 includes a mixer 641 excited by the first LO signal and configured to convert the RF_receive signal into a first baseband signal. The RF_receive signal may be filtered by a preselection filter (not shown), amplified by a low-noise amplifier (not shown) and then further filtered by a second preselection filter (not shown) before being applied to mixer 641. I_branch 640 further includes a first low-pass filter 642 coupled to mixer 641 and configured to filter out the LO signal component in the downconverted signal, at least one baseband gain amplifier 644 coupled to low-pass filter 642, and a second low-pass filter 646 coupled to baseband gain amplifier(s) 646 and configured to filter out noises caused by the baseband gain amplifier(s) 644. The output of filter 646 is the in-phase signal I_SIG. I-branch 640 may further include a comparator functioning as an analog to digital (A/D) converter 648 configured to generate a digital in-phase signal I_DIG from the I_SIG signal.

Likewise, Q-branch 650 includes a mixer 651 excited by the second LO signal and configured to convert the RF_receive signal into a second baseband signal. As in the I-branch, the RF_receive signal may be filtered by a preselection filter, amplified by a low-noise amplifier and then further filtered by a second preselectionfilter before being applied to mixer 651. Q_branch 650 further includes a first low-pass filter 652 coupled to the mixer and configured to filter out the LO signal component in the second baseband signal, at least one baseband gain amplifier 654 coupled to low-pass filter 652, and a second low-pass filter 656 coupled to baseband gain amplifier(s) 652 and configured to filter out noises caused by the baseband gain amplifier(s). The output of filter 656 is the quadrature signal Q_SIG. Q-branch may further include a comparator functioning as an A/D converter 658 configured to convert the Q_SIG signal into a digital quadrature signal Q_DIG.

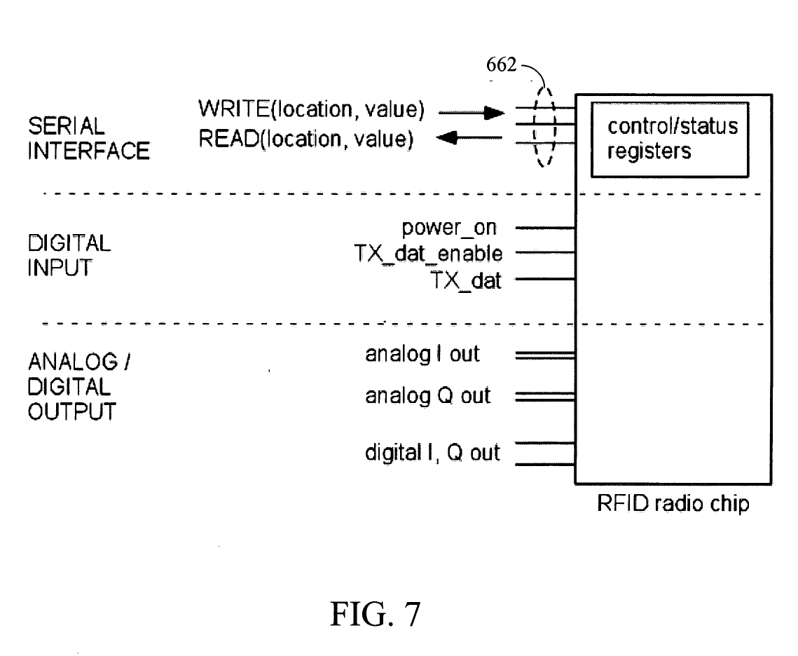

A conceptual input/output interface with the radio 510 is shown in FIG. 7. A convenient way to pass values into and out of the registers in reader 520 is to use a three-line emulation serial port interface (SPI) 662, though other means, such as a parallel bus interface, could be employed. Some key inputs, such as power-on and transmit-data-enable functions, and an input for transmitting digital data itself, must be attended to without delays contingent on writing to and reading from the register and are thus provided with dedicated digital inputs. The output of a homodyne receiver in the reader 510, which output is representative of the scattered signal from the tag, is divided into in-phase (I) and quadrature (Q) signal values, with their phases being defined with respect to the local oscillator. The output of the reader 510 can be the actual instantaneous analog I and Q voltages, which would then be sampled and digitized locally in the interface module 530. Digital sampling could alternatively take place within the RFID radio 510, as discussed above. Or, the I and Q outputs could drive comparators to provide a simple single-valued digital output, as in the case of a digitized voltage output with 1-bit resolution.

From the point of view of the custom reader interface driver 317 in the controller 120, all bits within the register block 660 in the RFID radio 510 in any minimal-function reader 110 can be adjusted by a WRITE command generally with the following syntax:

WRITE(location, length, values) associated with the MAC address of the relevant minimal-function reader 110. Similarly, all register values can be queried using generally the following READ command:

READ(location, length, values)

which is again associated with the relevant MAC address.

Transmit digital data could be sent one bit per packet, but it is much more efficient to send transmit data in RIN packets of a form such as:

TXDATA(length, values, timing information)

Data values from TXDATA packets are buffered by the interface module 530 and delivered at a requested rate to the RFID radio 510. Similarly, the interface module 530 optimally should buffer I and Q data from the radio 510, and then send packets of a form such as:

RXDATA(format, length, values, timing information)

to communicate the received signals back to the controller 120.

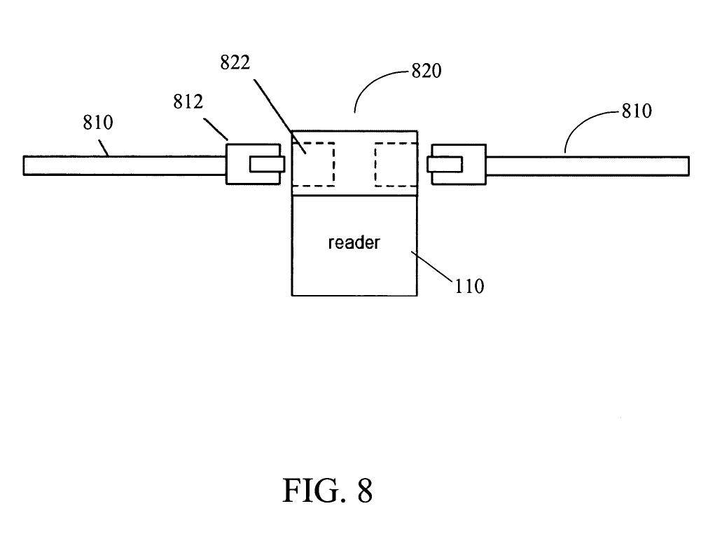

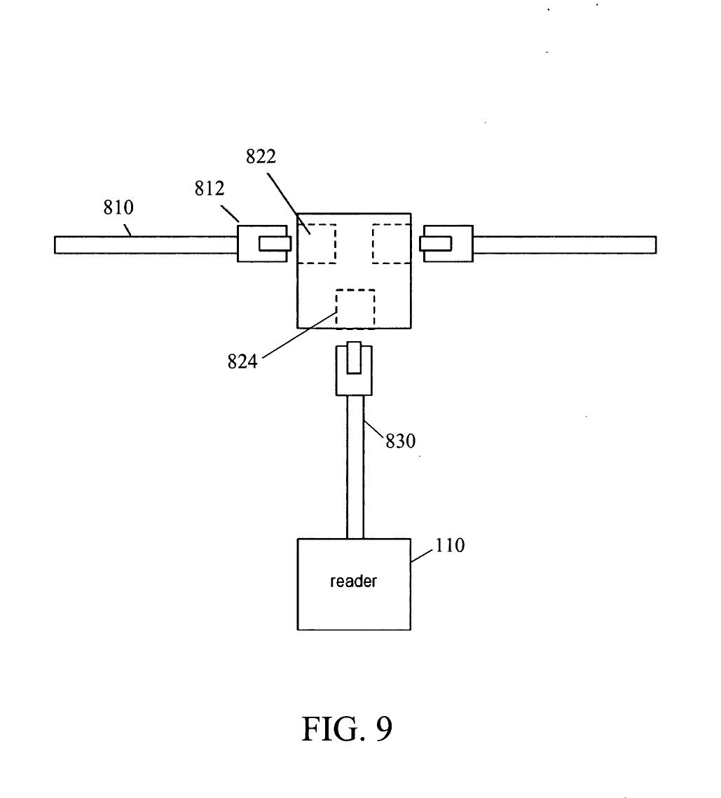

In one embodiment, each of the minimal-function readers 110 is incorporated into the network-compatible cable 130 during manufacture. Alternatively, the network-compatible cable 130 may be constructed of connectable sections 810 each having connectors 812 at one or both ends so that the cable sections 810 can be connected by adaptors 820 each bearing receptacles 822 for connecting with the cable sections 810, as shown in FIG. 8. An adaptor may either incorporate a minimal-function reader 110, as shown in FIG. 8, or provide an additional receptacle 824 allowing a relatively remotely-situated reader 510 to be connected thereto through an additional network-compatible cable 830 having a variable length, as shown in FIG. 9.

This invention has been described in terms of a number of embodiments, but this description is not meant to limit the scope of the invention. Numerous variations will be apparent to those skilled in the art, without departing from the spirit and scope of the invention disclosed herein.

What is claimed is:

1. An RFID reader system comprising:
a controller; and
a plurality of low-power UHF or microwave RFID readers coupled to the controller.

2. The RFID reader system of claim 1 wherein the controller includes a network interface for communicating with the readers.

3. The RFID reader system of claim 2 wherein the network interface is an IEEE 802.3 standard Ethernet interface.

4. The RFID reader system of claim 1 further comprising a network-compatible cable to facilitate communication between the controller and the plurality of RFID readers.

5. The RFID reader of claim 4 wherein each of at least some of the plurality of RFID readers is incorporated into the network compatible cable.

6. The RFID reader system of claim 4 wherein each of the plurality of RFID readers includes an RFID radio coupled to at least one antenna, an Ethernet interface coupled to the network-compatible cable, and an interface module coupled between the RFID radio and the Ethernet interface.

7. The RFID reader system of claim 6 wherein the RFID radio includes registers that can be written to or read from by the controller.

8. The RFID reader system of claim 4 wherein the network-compatible cable includes a plurality of connectable cable sections and at least one adaptor for connecting two neighboring cable sections.

9. The RFID reader system of claim 8 wherein each of at least some of the plurality of RFID readers is incorporated in one of the at least one adaptor.

10. The RFID reader system of claim 8 wherein the at least one adaptor includes two receptors for connecting to respective ones of two neighboring cable sections and a third receptor for connecting with one of the plurality of RFID readers through a network-compatible cable.

11. The RFID reader system of claim 1 wherein each of the plurality of RFID reader has a unique network address.

12. The RFID reader system of claim 1 wherein the controller is configured to address a subset of at least one of the plurality of RFID readers at a time and to cause the at least one RFID reader to transmit interrogation signals.

13. The RFID reader system of claim 12 wherein the controller is configured to generate a reader interface packet to address the subset of the RFID readers.

14. The RFID reader system of claim 13 wherein the reader interface packet is encapsulated in a IEEE 802.3-compliant header.

15. The RFID reader system of claim 1 wherein the controller includes a memory for storing physical locations of the plurality of the RFID readers.

16. The RFID reader system of claim 1 further comprising a plurality of RFID tags with identifications and physical locations known to the controller, at least one of the RFID tags being placed in close proximity to each RFID reader.

17. The RFID reader system of claim 1 wherein the plurality of RFID readers are placed in compartmentalized areas to allow at least one RFID reader in each of the compartmentalized area, and wherein the controller is configured to address each RFID reader individually, and to direct each addressed RFID reader to read or write to RFID tags also placed in the same compartmentalized area with the RFID reader.

18. A method for interrogating RFID tags in compartmentalized areas, comprising:
placing a plurality of RFID readers coupled to a controller through a network interface in the compartmentalized areas;
addressing a first subset of at least one of the plurality of RFID readers from the controller to interrogate RFID tags located in a first subset of at least one of the compartmentalized areas during a first time period; and
addressing a second subset of at least one of the plurality of RFID readers from the controller to interrogate RFID tags located in a second subset of at least one of the compartmentalized areas during a second time period after the first time period.

19. The method of claim 18 wherein the step of placing comprises placing the plurality of the RFID readers in the compartmentalized areas such that at least one of the plurality of RFID readers is situated in each area.

20. The method of claim 18 wherein the plurality of RFID readers are coupled to the controller via a network-compatible cable, and wherein each step of addressing comprises sending from the controller a reader interface packet down the network-compatible cable, the reader interface packet including at least one unique address corresponding to the first or second subset of RFID readers.
